(19) United States
(12) Patent Application Publication
(10) Pub. No.: US 2024/0087250 A1
(43) Pub. Date: Mar. 14, 2024

(54) METHODS AND SYSTEMS FOR MANAGING IMAGES IN AUGMENTED REALITY (AR) ENVIRONMENT

(71) Applicant: DISH Network L.L.C., Englewood, CO (US)

(72) Inventors: Luke E. VanDuyn, Conifer, CO (US); Caroline Condon, Denver, CO (US); Amber Bellerjeau, Littleton, CO (US)

(21) Appl. No.: 17/944,766

(22) Filed: Sep. 14, 2022

(51) Int. Cl. G06T 19/00; G06F 16/535; G06T 19/20; G06V 20/20

(52) U.S. Cl. CPC G06T 19/006; G06F 16/535; G06T 19/20; G06V 20/20; G06T 2200/24

(57) ABSTRACT

A technique is directed to methods and systems for managing image information. In some implementations, the method includes (1) providing user information regarding a user location and a user preference of image information; (2) receiving, at a client device, one or more sets of image information associated with one or more items of interests in an AR environment based on the user information; and (3) generate, at the client device, a user interface for displaying the one or more sets of image information.

### BACKGROUND

Augmented reality (AR) related technology has been used to demonstrate or showcase real world items in a semi-virtual environment. Conventional AR systems do not provide effective user interface as well as sufficient information for users to explore and interact. Therefore, it is advantageous to have an improved system and method to address the foregoing needs.

### BRIEF DESCRIPTION OF THE DRAWINGS

FIG. 1 is a schematic diagram illustrating a system for managing information associated with an item of interest in accordance with some implementations of the present disclosure.

FIG. 2 is a schematic diagram illustrating a user interface in accordance with some implementations of the present disclosure.

FIG. 3 is a block diagram illustrating an overview of devices on which some implementations can operate.

FIG. 4 is a block diagram illustrating an overview of an environment in which some implementations can operate.

FIGS. 5 and 6 are flow diagrams illustrating processes in some implementations in accordance with the present disclosure.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to methods and systems for managing images (or any other suitable information that can be displayed with the images) in an AR environment. More particular, the present systems enable multiple chronological images associated with an item (e.g., a historical building, an ancient ruin, a street, an area, an administrative area, etc.) to be displayed in a user interface in the AR environment. In some embodiments, the present systems enable user customization of the user interface, including adding suitable tool bars or reference tags. In some embodiments, the present systems also provide information regarding the displayed images (e.g., metadata, credits, sources, providers, links, descriptions, comments, etc.).

For example, the present system enables a user to explore a city in an AR environment. The user can first identify an item of interest (e.g., a historic building). The present system can then initiate a user interface in the AR environment, and display images associated with the identified item of interest. The images can be in a chronological order, showing how the item looked like in the past few decades. The user interface also enables the user to interact with the displayed images, such as adding comments or tags to them, providing edits, saving the images locally, etc.

One aspect of the present disclosure is that it provides online image sourcing for an item of interests. The present system can (1) search available images (and other suitable information) in public domain (and/or other private sources that the present system has access to); (2) sort/filter the searched images in a chronological order based on a user preference (e.g., “before 1980,” “war world II,” “civil world,” from a certain image source, etc.); and (3) visually display the sorted images in a user interface in an AR environment.

Another aspect of the present disclosure is that it provides an application (e.g., a “Rewind” app) installed in a client-side device. The application enables a user to (1) explore an AR environment; (2) identify an item of interest; (3) view images in a chronological order based on a user preference; and (4) interact with the shown images. In some embodiments, the application enables the user to customize the user interface such that the user can have a customized AR experience.

In some embodiments, the present system (1) uses a phone's location data to determine approximately where a user is; (2) determines what exactly the user is looking at (e.g., one or more items of interests; based on a trained model); and then (3) provides options associated with the determined items of interests for the user to view. The options can include images of multiple items of interests, as well as how the user would like to present the images in a user interface.

In some embodiments, the present system includes a processing unit configured to compare a current image (e.g., an image captured by a user device) with an existing image in a source in the public domain (e.g., library, archive, image database, etc.). Based on the comparison (e.g., overlaying the current image over the top of the existing image), the present system can ensure that the existing image and the current image are aligned in the system. By this arrangement, when a user initiates a request to view these images, the system can instruct the user how to move so as to best align these images.

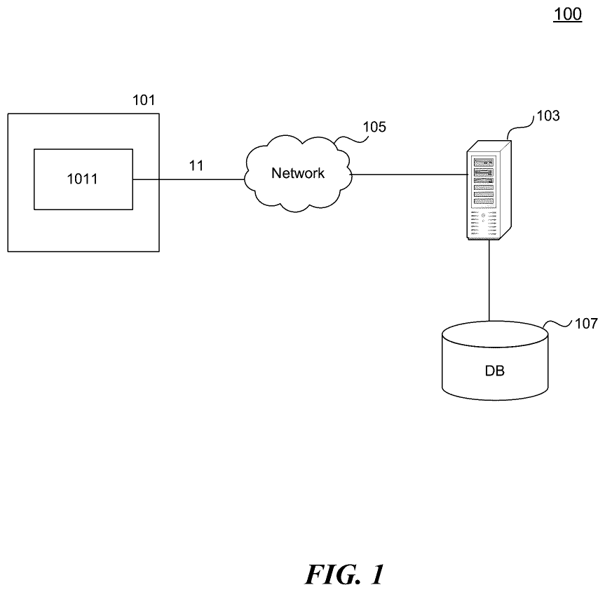

Several implementations are discussed below in more detail in reference to the figures. FIG. 1 is a schematic diagram illustrating a system 100 for managing information (e.g., images) associated with an item of interest in accordance with some implementations of the present disclosure. The system 100 includes a client device 101 in communication with a server 103 via a network 105. The client device 101 includes an application (“Rewind” app) 1011 installed.

The client device 101 is configured to receive image information 11 from the server 103 via the network 105. In some embodiments, the network 105 can be the Internet. In some embodiments, the network 105 can be a 5G network or a satellite network.

In some embodiments, the image information 11 includes images, videos, pictures, etc., as well as other suitable, supplemental information associated with the images, such as descriptions, metadata, credits, sources, providers, links, descriptions, comments, etc.

In some embodiments, the application 1011 is configured to enable a user to view the image information 11 in an AR environment. The application 1011 is also configured to provide a user interface for the user to view and interact with presented components (e.g., based on the image information) in the user interface.

In some embodiments, the application 1011 can verify, adjust, and/or edit the image information 11. In some embodiments, the foregoing processes can be performed based on a trained model. For example, the trained model can include multiple parameters with different weighting values, and each of the parameters contributes or relate to the foregoing synchronization process to a certain extent (e.g., indicated by the weighting values). The multiple parameters can include, for example, user locations, popularity of items to be viewed, etc. In some embodiments, the foregoing processes can be implemented by the server 103.

In some embodiments, the application 1011 can generate customized user interface based on the image information 11. For example, the customized user interface can be decided based on a user selection, a predicted user preference (e.g., according to prior viewing history), etc.

The server 103 can further connect to a database 107. The database 107 is configured to store data and information such as the image information 11 and other associated information, data analyzed or trained by the server 103, user profile information (e.g., user preferences, user subscription plans, types or configurations of user devices, etc.) and/or other suitable information.

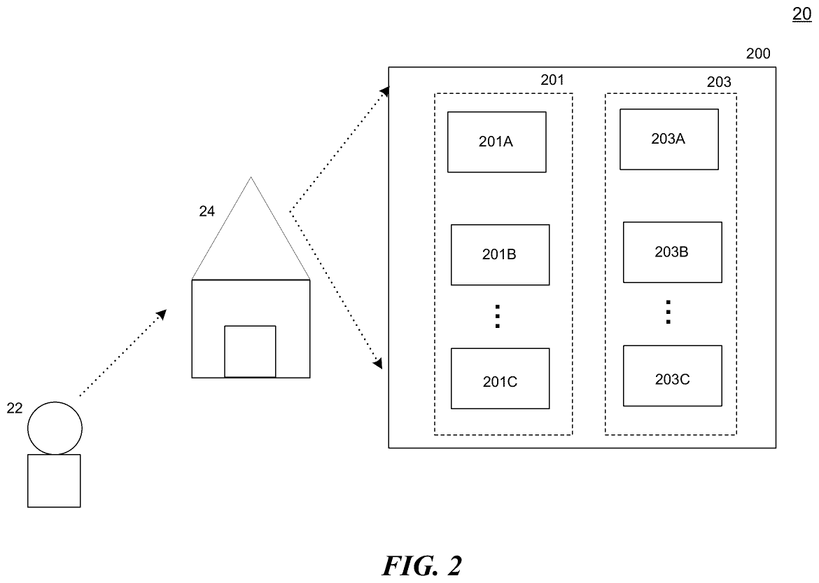

FIG. 2 is a schematic diagram illustrating a user interface 200 in accordance with some implementations of the present disclosure. FIG. 2 illustrates an AR environment 20 where a user 22 can observe an item of interest 24 (e.g., a historic building). The user interface 200 can be generated to enable the user 22 to view images and other information associated with the item of interest 24.

For example, the user interface 200 can include a first section 201 and a second section 203. The first section 201 is configured to display images 201A-C associated with the item of interest 24 in a chronological order. The second section 203 is configured to display information (e.g., descriptions, links, sources, etc.) associated with the images 201A-C in the chronological order. In some embodiments, the user interface 200 can be customized based on a user preference.

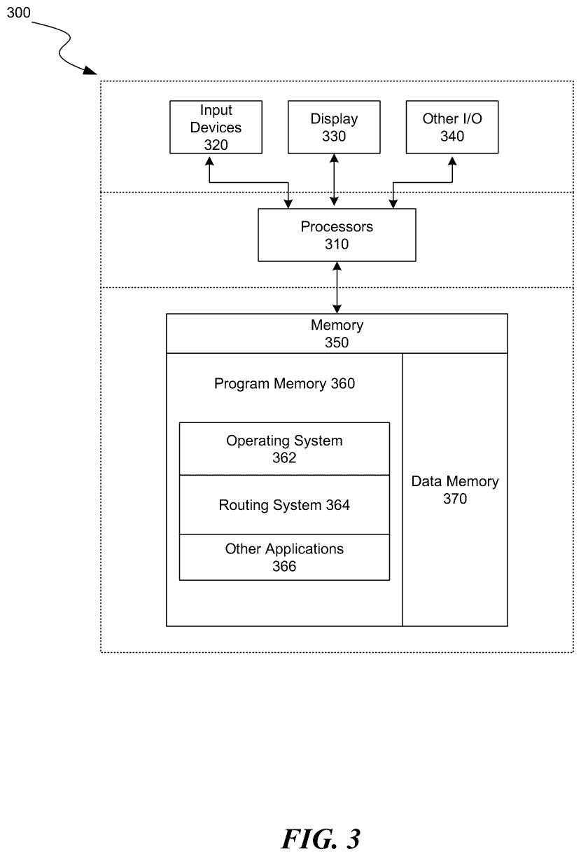

FIG. 3 is a block diagram illustrating an overview of devices (e.g., the server 103, the client device 101, etc.) on which some implementations can operate. Device 300 can include one or more input devices 320 that provide input to the processor(s) 310 (e.g., CPU(s), GPU(s), etc.), notifying it of actions. The actions can be mediated by a hardware controller that interprets the signals received from the input device and communicates the information to the processors 310 using a communication protocol. Input devices 320 include, for example, a mouse, a keyboard, a touchscreen, an infrared sensor, a touchpad, a wearable input device, a camera- or image-based input device, a microphone, or other user input devices.

Processors 310 can be a single processing unit or multiple processing units in a device or distributed across multiple devices. Processors 310 can be coupled to other hardware devices, for example, with the use of a bus, such as a PCI bus or SCSI bus. The processors 310 can communicate with a hardware controller for devices, such as for a display 330. Display 330 can be used to display text and graphics. In some implementations, the display 330 provides graphical and textual visual feedback to a user. In some implementations, the display 330 includes the input device as part of the display, such as when the input device is a touchscreen or is equipped with an eye direction monitoring system. In some implementations, the display is separate from the input device. Examples of display devices include an LCD display screen, an LED display screen, a projected, holographic, or augmented reality display (such as a heads-up display device or a head-mounted device), and so on. Other I/O devices 340 can also be coupled to the processor, such as a network card, video card, audio card, USB, firewire or other external device, camera, printer, speakers, CD-ROM drive, DVD drive, disk drive, or Blu-Ray device.

In some implementations, the device 300 also includes a communication device capable of communicating wirelessly or wire-based with a network node. The communication device can communicate with another device or a server through a network using, for example, TCP/IP protocols. The device 300 can utilize the communication device to distribute operations across multiple network devices.

The processors 310 can have access to a memory 350 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 350 can include program memory 360 that stores programs and software, such as an operating system 362, routing system 364 (e.g., for implementing the routing plan discussed herein), and other application programs 366. The memory 350 can also include data memory 370, user interface data, event data, image data, biometric data, sensor data, device data, location data, network learning data, application data, alert data, structure data, camera data, retrieval data, management data, notification data, configuration data, settings, user options or preferences, etc., which can be provided to the program memory 360 or any element of the device 300.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

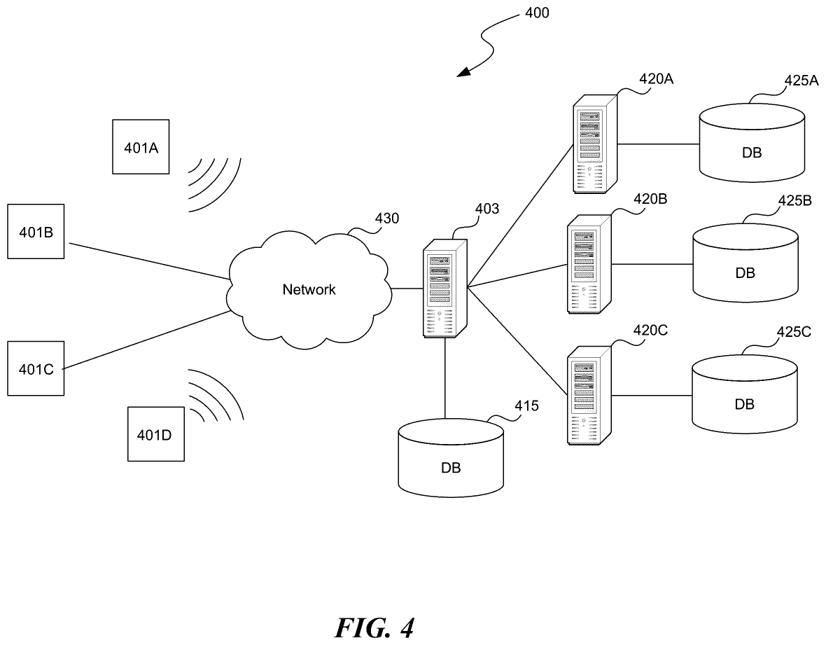

FIG. 4 is a block diagram illustrating an overview of an environment 400 in which some implementations can operate. The environment 400 can include one or more client computing devices 401A-D, examples of which can include the client device 101. The client computing devices 401 can operate in a networked environment using logical connections through network 430 to one or more remote computers, such as a server computing device 403.

In some implementations, the server computing device 403 can be an edge server which receives client requests and coordinates fulfillment of those requests through other servers, such as servers 420A-C. Server computing devices 403 and 420 can comprise computing systems, such as the device 300 discussed above. Though each server computing device 403 and 420 is displayed logically as a single server, server computing devices can each be a distributed computing environment encompassing multiple computing devices located at the same or at geographically disparate physical locations. In some implementations, each server 420 corresponds to a group of servers.

The client computing devices 401 and the server computing devices 403 and 420 can each act as a server or client to other server/client devices. Server 403 can connect to a database 415. Servers 420A-C can each connect to a corresponding database 425A-C. As discussed above, each server 420 can correspond to a group of servers, and each of these servers can share a database or can have their own databases.

The databases 415/425 can store information such as implement data, user interface data, event data, image data, detection data, biometric data, sensor data, device data, location data, network learning data, application data, alert data, structure data, camera data, retrieval data, management data, notification data, configuration data. Though databases 415/425 are displayed logically as single units, databases 415 and 425 can each be a distributed computing environment encompassing multiple computing devices, can be located within their corresponding server, or can be located at the same or at geographically disparate physical locations.

Network 430 can be a local area network (LAN) or a wide area network (WAN), but can also be other wired or wireless networks. The network 430 may be the Internet or some other public or private network. The client computing devices 401 can be connected to the network 430 through a network interface, such as by wired or wireless communication. While the connections between server 403 and servers 420 are shown as separate connections, these connections can be any kind of local, wide area, wired, or wireless network, including network 430 or a separate public or private network.

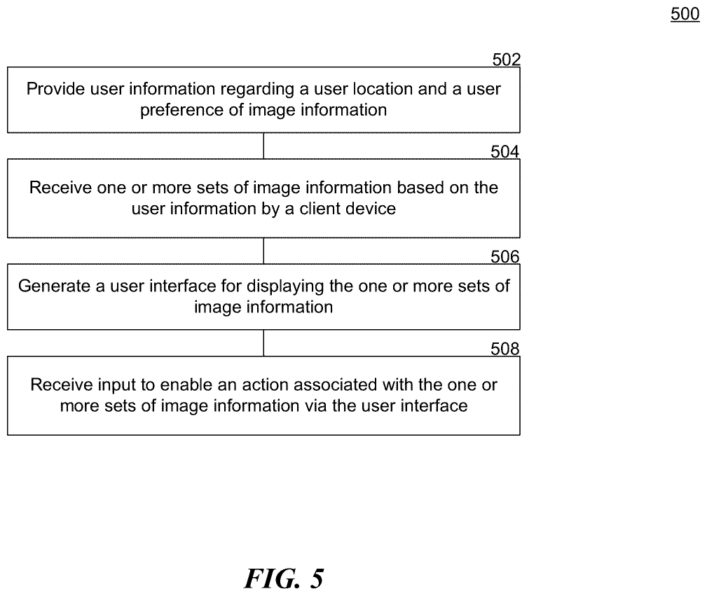

FIG. 5 is a flow diagram illustrating a method 500 used in some implementations for managing image information associated with an item of interests. In some embodiments, the method 500 can be implemented by a client device (e.g., the client device 101) discussed herein.

At block 502, the method 500 start by providing user information regarding a user location and a user preference of image information. In some embodiments, the user information can include a user selection of images to be displayed (e.g., a server sends a request and then receives a response including the user selection from the client device). In some embodiments, the user preference of image information includes a criterion defining at least one characteristic of images (e.g., color, size, resolution, sources, creation dates, etc.).

At block 504, the method 500 can continue by receiving one or more sets of image information based on the user information by the client device. The one or more sets of image information includes images and other suitable information associated with one or more items of interests that can be visually presented in an AR environment.

At block 506, the method 500 continues by generating a user interface for displaying the one or more sets of image information. Embodiments of the user interface are discussed in detail with reference to FIG. 2.

At block 508, the method 500 continues by receiving input to enable an action associated with the one or more sets of image information via the user interface. Examples of the action include, for example, adding comments or tags, providing edits, saving the images locally, etc.

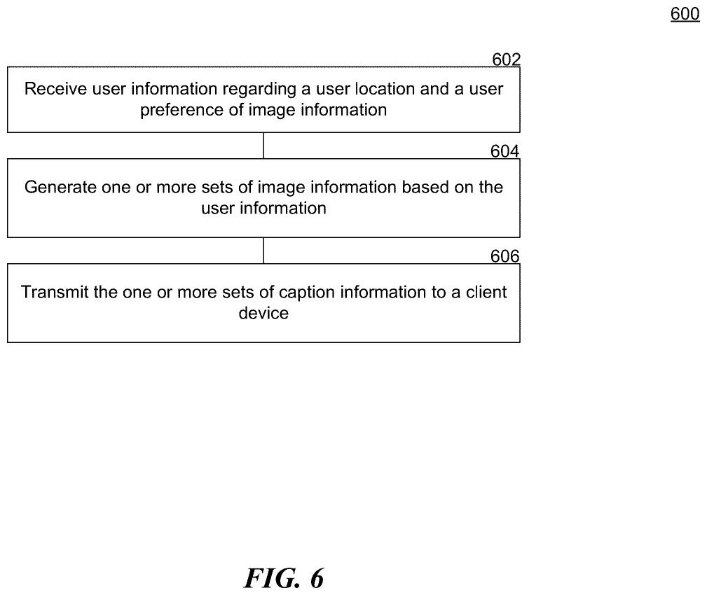

FIG. 6 is a schematic diagram illustrating a method 600 for managing image information associated with items of interests. The method 600 can be implemented by a server (e.g., the server 103). At block 602, the method 600 starts by receiving user information regarding a user location and a user preference of image information. In some embodiments, the user location can be obtained based on a location of a portable device carried by the user. In some embodiments, the user information can include a user selection of images of interests. In some embodiments, the user information can be obtained based on the server's prediction based on user's subscription history, user profile, viewing history, etc.

At block 604, the server can generate one or more sets of image information based on the user information. In some embodiments, the server identifies one or more items of interests and then generates one or more sets of image information for the identified items of interests. In some embodiments, the one or more sets of image information are generated based on searching and filtering available images associated with the items of interests. These images can be searched and filter based on the user preference and/or the user location.

At block 606, the method 200 continues by transmitting the one or more sets of image information to a client device. The transmitted image information is then be displayed via a user interface implemented by the client device.

Those skilled in the art will appreciate that the components illustrated in FIGS. 1-6 described above, and in each of the flow diagrams discussed below, may be altered in a variety of ways. For example, the order of the logic may be rearranged, sub-steps may be performed in parallel, illustrated logic may be omitted, other logic may be included, etc. In some implementations, one or more of the components described above can execute one or more of the processes described below.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

Unless explicitly excluded, the use of the singular to describe a component, structure, or operation does not exclude the use of plural such components, structures, or operations. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

As used herein, the expression “at least one of A, B, and C” is intended to cover all permutations of A, B and C. For example, that expression covers the presentation of at least one A, the presentation of at least one B, the presentation of at least one C, the presentation of at least one A and at least one B, the presentation of at least one A and at least one C, the presentation of at least one B and at least one C, and the presentation of at least one A and at least one B and at least one C.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method, comprising:
providing user information regarding a user location and a user preference of image information;
receiving, at a client device, one or more sets of image information associated with one or more items of interests in an AR environment based on the user information;
generate, at the client device, a user interface for displaying the one or more sets of image information; and
receiving input to enable an action associated with the one or more sets of image information via the user interface.

2. The method of claim 1, wherein the user location is a location from a portable device carried by a user.

3. The method of claim 1, wherein the user preference of image information includes a criterion defining at least one characteristic of images.

4. The method of claim 1, wherein the one or more items of interests include a historic building.

5. The method of claim 1, wherein the one or more sets of image information include a set of images in a chronological order, and wherein the method further comprises comparing a current image captured by the client device with the set of images.

6. The method of claim 1, wherein the user interface includes a first section and a second section, wherein the first section is configured to display images associated with the one or more items of interest in a chronological order.

7. The method of claim 6, wherein the second section is configured to display information associated with the images in the chronological order.

8. The method of claim 7, wherein the information associated with the images includes at least one of the following: a description, al ink, a source, a comment, and metadata.

9. The method of claim 1, wherein the action associated with the one or more sets of image information includes at least one of the following: adding a comment or tag, providing an edit, and saving the image information at the client device.

10. A method, comprising:
receiving, at a server, user information regarding a user location and a user preference of image information;
generating, at the server, one or more sets of image information associated with one or more items of interests in an AR environment based on the user information; and
transmitting the one or more sets of image information to a client device, wherein the transmitted image information is configured to be displayed via a user interface implemented by the client device.

11. The method of claim 10, wherein the user location is a location from the client device carried by a user.

12. The method of claim 10, wherein the user preference of image information includes a criterion defining at least one characteristic of images.

13. The method of claim 10, wherein the one or more items of interests include a historic building.

14. The method of claim 10, wherein the one or more sets of image information include a set of images in a chronological order.

15. The method of claim 10, wherein the user interface includes a first section and a second section, wherein the first section is configured to display images associated with the one or more items of interest in a chronological order.

16. The method of claim 15, wherein the second section is configured to display information associated with the images in the chronological order.

17. The method of claim 16, wherein the information associated with the images includes at least one of the following: a description, al ink, a source, a comment, and metadata.

18. The method of claim 1, further comprising generating the one or more sets of image information associated with one or more items of interests based on searching available images in one or more databases based on the user information.

19. The method of claim 1, further comprising generating the one or more sets of image information associated with one or more items of interests based on filtering searched images in one or more databases based on the user information.

20. A computing system comprising:
at least one processor; and
at least one memory storing instructions that, when executed by the processor, cause the computing system to perform a process comprising:
providing user information regarding a user location and a user preference of image information;
receiving, at a client device, one or more sets of image information associated with one or more items of interests in an AR environment based on the user information;
generate, at the client device, a user interface for displaying the one or more sets of image information; and
receiving input to enable an action associated with the one or more sets of image information via the user interface.
